(19) United States
(12) Patent Application Publication
(10) Pub. No.: US 2008/0046411 A1
(43) Pub. Date: Feb. 21, 2008

(54) Method and System for Managing the Impressing of the Search Listing Based on Advertisement Group

(75) Inventor: Woo Sung Lee, Seoul (KR)

Correspondence Address: BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 11/568,907

(22) PCT Filed: May 27, 2005
(86) PCT No.: PCT/KR05/01560

§ 371 Date: Nov. 9, 2006

(30) Foreign Application Priority Data
May 29, 2004 (KR) 10-2004-0038661

(51) Int. Cl. G06F 17/30

(52) U.S. Cl. 707/3; 707/E17.108

(57) ABSTRACT

Disclosed are method and system for managing an impression of a search listing, the comprising the steps of: maintaining a search information database for storing a keyword and a search listing corresponding thereto; selecting the predetermined number of keywords from the stored keywords and recording the selected keyword in a predetermined advertising record; associating the at least one advertising record with an advertising group; extracting a search listing corresponding to an inputted keyword for a search request by referring to the search information database; and controlling the extracted search listing to be displayed by referring to an advertising record associated with the inputted keyword; wherein the advertising record includes information on a ranking of an advertising impression location where the search listing is displayed; and the step of controlling the extracted search listing to be displayed comprises the step of: performing predetermined bidding process at the advertising impression location and determining whether it is possible to display the extracted search listing.

### TECHNICAL FIELD

The present invention relates to method and system for managing an impression of a search listing, and more particularly, to method and system for managing an impression of a search listing, in which hierarchical advertising management is embodied by associating at least one advertising record with an advertising group and collectively cutting off display of a search listing based on control of attribute of an advertising condition and satisfaction of an advertising closing condition.

### BACKGROUND ART

Recently, as the Internet gets popular, an information search service providing a searcher with brief information about an advertiser in response to a question inputted by the searcher via a search engine is being actively operated. Through the information search service, the advertiser can promote his/her own company to the searcher.

Generally, the advertiser is required to go through an enrollment process for making a predetermined contract with an individual search engine, in order to display brief information about the advertiser via the information search service. The predetermined contract may relate to an advertising condition associated with display of brief information, advertising costs caused by display of brief information, a closing condition for cutting off display of brief information, and the like. It should be noted that the advertiser is annoyed to make a contract with a plurality of search engines one by one in order to register brief information. Also, in case of making an individual contract with the search engine, there is a concern that management of advertising itself with respect to display of brief information gets complicated and systematic management is not easy.

In order to overcome the difficulty, Korean Patent Application No. 10-2002-69485 (hereinafter, the application) discloses the invention providing advertisers with a method for managing one or more search listings associated with search advertising using a group (category). Through this, the application enables a URL, a title, an explanation, etc, of search listing included in a category to be corrected when the advertiser inputs a keyword correction. Also, the application enables systematic and easy management with respect to search listings.

However, in the application, targets for correction to which advertising management performs are limited to contents of a search list which is brief information about the advertiser. Also, in the application, in case of change of advertising condition or selective correction of the search list, the advertiser still has to correct/change the advertising condition or the search list individually.

Also, the application cannot provide a full advertising management service, such as compiling a budget for a search engine, flexibly adjusting the number of clicks, or the like, in accordance with marketing strategies of the advertiser. Thus, there is a problem that the advertiser cannot perform an efficient advertising act.

In the meantime, advertisers may require that brief information be no more displayed when advertising effects planned by the advertisers or actual sales are accomplished. This is so as not to generate unnecessary advertising costs. However, advertising management methods so far display brief information unilaterally in accordance with contracts made when the brief information is registered, and advertising effects generating by display of brief information or actual sales are not considered.

Accordingly, there is required a new type of a model for managing an impression of a search listing, capable of flexibly controlling display of brief information in accordance with an advertiser's marketing strategies, not an existing method of simply grouping search listings. Also, there is required a model of managing an impression of a search listing in which overall attribute change is induced in such a manner that an impression target for display of brief information is adjusted by inputting of variable data one time.

### DISCLOSURE OF INVENTION

Technical Goals

The present invention is conceived to solve the aforementioned problems. Thus, the present invention provides method and system for managing an impression of a search listing, which can group at least one advertising record associated with extraction of the search listing into one advertising group and collectively change attribute for the grouped advertising record as a variable element for extraction of the search listing is inputted into the advertising group.

The present invention also provides method and system for managing an impression of a search listing, which limit an impression target for display of brief information by a region, an age, and a sex based on an advertiser's selection, thereby displaying the search listing to a searcher only who is most suitable for marketing strategies of the advertiser.

The present invention also provides method and system for managing an impression of a search listing, which cut off display of the advertising listing when advertising execution information generated by a searcher's selection satisfies a predetermined advertising closing condition, thereby enabling the advertiser to actively control his/her own advertising.

The present invention also provides method and system for managing an impression of a search listing, which guarantee diversity of a search mode extracting search listings based on a method of determining whether a keyword causing the extraction is associated with a keyword inputted for a search request.

Technical Solutions

In order to achieve the above goals, according to an aspect of the present invention, there is provided a method for managing an impression of a search listing, the method including the steps of: maintaining a search information database for storing a keyword and a search listing corresponding thereto; selecting the predetermined number of keywords from the stored keywords and recording the selected keyword in a predetermined advertising record; associating the at least one advertising record with an advertising group; extracting a search listing corresponding to an inputted keyword for a search request by referring to the search information database; and controlling the extracted search listing to be displayed by referring to an advertising record associated with the inputted keyword; wherein the advertising record includes information on a ranking of an advertising impression location where the search listing is displayed; and the step of controlling the extracted search listing to be displayed includes the step of: performing predetermined bidding process at the advertising impression location and determining whether it is possible to display the extracted search listing.

Also, according to another aspect of the present invention, there is provided a system for managing an impression of a search listing, the system including: an advertising record for recording impression information associated with display of the search listing; an advertising group associating the at least one advertising record; an advertising condition receiving unit recording a predetermined advertising closing condition in the advertising group; a result providing unit providing a searcher with a predetermined search listing based on the impression information, in response to a search request of the searcher; an execution information generating unit receiving a selection of the searcher with respect to the provided search listing and recording advertising execution information generated in association with the selection, in the advertising group; and an operation control unit comparing the recorded advertising execution information and the advertising closing condition and in case that the advertising execution information satisfies the advertising closing condition, cutting off providing of a search listing by the advertising record associated with the advertising group.

### BRIEF DESCRIPTION OF THE DRAWINGS

FIG. 1 is a schematic diagram illustrating operations of an impression management system according to the present invention, and

FIG. 2 is a diagram illustrating a specific hierarchical structure of an impression management system organizing a unit hierarchy;

FIG. 3 is a configuration diagram illustrating an impressing management system according to a preferred embodiment of the present invention;

FIGS. 4 and 5 are diagrams illustrating search listings extracted to each of partner sites according to the present invention;

FIG. 6 is a flowchart illustrating a method for managing an impression of a search listing according to a preferred embodiment of the present invention;

FIG. 7 is a flowchart illustrating one example of a method for associating an advertising group according to the present invention,

FIG. 8 is a flowchart illustrating one example of a method for performing a bidding process based on a unit click cost and click through rate (CTR), and

FIG. 9 is a flowchart illustrating one example of a method for determining a search listing to be displayed by a bidding method at a particular advertising impression location;

FIG. 10 is a flowchart illustrating one example of a method for confining an impression target of a search listing according to the present invention;

FIG. 11 is a flowchart illustrating one example of a method for changing attribute of an advertising record according to the present invention;

FIG. 12 is a flowchart illustrating one example of a method for computing advertising costs according to the present invention, and

FIG. 13 is a flowchart illustrating one example of a method for specifying a partner site on which a search listing is displayed;

FIG. 14 is a flowchart illustrating an impression management method for cutting off extraction of a search listing based on an advertising closing condition according to the present invention; and

FIG. 15 is an inner block diagram of a general-purpose computer which can be employed to perform an impression management method according to the present invention.

### BEST MODE FOR CARRYING OUT THE INVENTION

Hereinafter, method and system for managing an impression of a search listing will be described with reference to the accompanying drawings.

An advertising group employed herein is to selectively display search listings about an advertiser on a plurality of advertising media. Thus, the advertising group may be an advertising management structure for performing a hierarchical management with respect to an advertising record specifying the advertising media where the search listings are displayed. That is, the advertising group organizes at least one advertising record to systematically perform an advertising act (display of the search listing) for the advertiser. Also, in case that a modification occurs in the advertising act, the modification is collectively reflected to all the advertising records included in the advertising group, thereby enhancing convenience in management of advertising. The search listing may be one item of search results extracted in response to a search request generated when a searcher inputs a keyword into a search engine, a kind of advertising medium. That is, the search listing includes information associated with a web page or a web site of an advertiser 130 corresponding to a keyword inputted by a searcher 120. Also, the search listing may include a tile of the web page or the web site, a URL thereof, and brief description thereof. Together with a function of general search results, the search listing also has a function of providing a searcher with advertising information about an advertiser at a search engine, thereby generating predetermined advertising effects, such as for example, connecting the searcher to a web site of the advertiser.

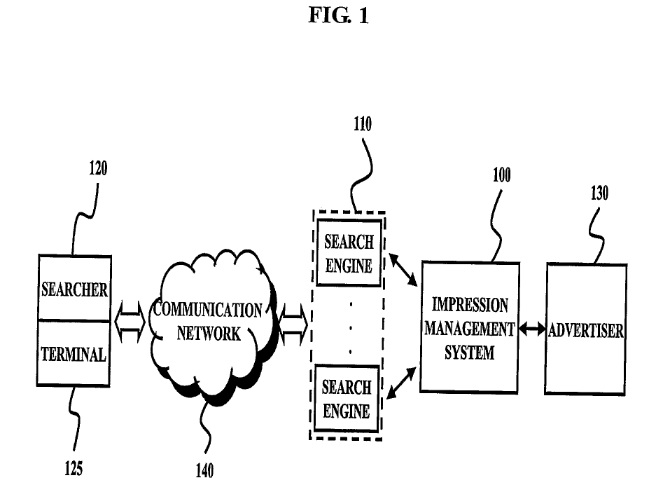

FIG. 1 is a schematic diagram illustrating operations of an impression management system according to the present invention.

An impression management system 100 is a unit organizing unit hierarchies which control a predetermined advertising condition, as a hierarchical structure such as a pyramid structure, thereby systematically managing an advertising act of the advertiser 130. At this time, the unit hierarchies are a structure to embody the advertising condition step by step, and grouped into an advertiser account, a campaign, and an advertising group at the highest, and an advertising record at the lowest, based on a scale of advertising management, an operation type thereof, and the like. Also, since controlling/controlled relationship is established among different unit hierarchies, it is possible to change the advertising condition collectively and selectively. For example, in case that a variable element occurs with respect to the advertising condition, the impression management system 100 controls an advertising condition of a corresponding unit hierarchy to be changed collectively. At this time, the impression management system 100 can identify a location of the unit hierarchy where the variable element occurs, and limit the variable element to be reflected selectively only in another unit hierarchy under the control of the identified unit hierarchy. Detailed description related thereto will be described later.

First, a search engine 110 may be a search program or a search web server supporting search operations to help easy access to a web site having content materials that the searcher 120 wants. That is, the search engine 110 serves to provide the searcher 120 with brief information (preferably, a search listing of the present invention) about the advertiser 130 who can provide information in response to a search request of the searcher 120, thereby saving time searching content materials and enhancing accuracy of search materials. Particularly, extracted brief information (search listing) includes link information. Thus, in case that the searcher 120 selects brief information (search listing) displayed on a terminal 125 using an instruction input tool such as a mouse, the search engine 110 enables a connection between the corresponding advertiser 130 and the searcher 120 who has generated the selection.

The searcher 120 may be an Internet user who maintains the terminal 125 to access the search engine 110 and inputs a keyword into the search engine 110 to generate a search request for a web site of the advertiser 130 maintaining content materials that the searcher 120 wants to search for.

The terminal 125 maintains a connection state with the impression management system 100 of the present invention through a communication network 140 such as the Internet and the like. Also, the terminal 125 displays at least one search listing extracted by the search engine 110 on a predetermined screen. The terminal 125 such constructed may be a general concept for terminals with a computing function by mounting a predetermined memory unit and a predetermined microprocessor, such as for example, personal computers, handheld computers, Personal Digital Assistants, MP3 players, electric dictionaries, cellular phones, smart phones, and the like.

The advertiser 130 is a CP (contents provider) who operates a web site whose location is designated on a network by a network address, such as for example, an IP address, a URL, a domain, and the like. The advertiser 130 pays predetermined advertising costs to a system operator of the present invention per a selection of the searcher 120 with respect to a search listing associated with the web site.

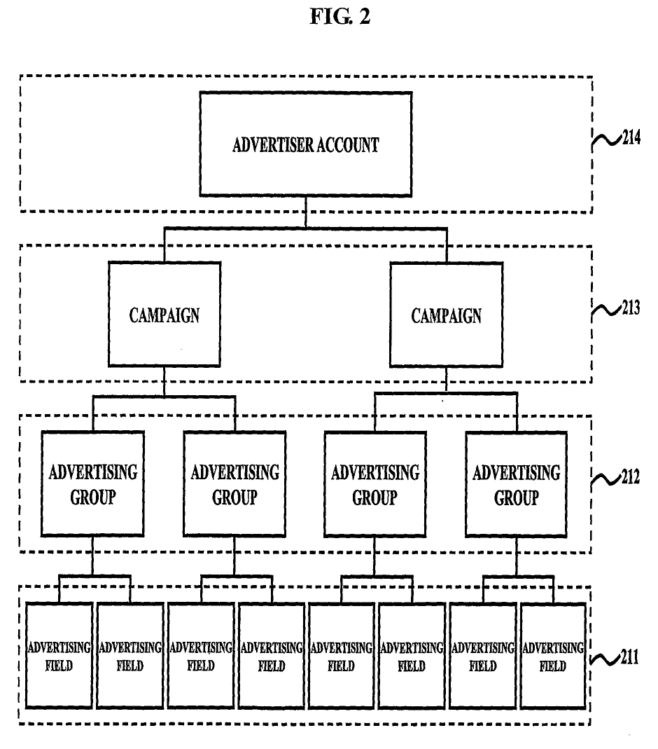

FIG. 2 is a diagram illustrating a specific hierarchical structure of an impression management system organizing a unit hierarchy.

As aforementioned, the unit hierarchy can be classified based on an operation type of a recorded advertising condition. Also, the number of unit hierarchies to be organized as the impression management system 100 can be flexibly determined by the system operator of the present invention considering the system environments. As illustrated in FIG. 2, the impression management system 100 is classified into four unit hierarchies, such as advertising fields 211, advertising groups 212, campaigns 213 and an advertiser account 214.

First, the advertising field 211 is a unit for extracting a search listing and recording impression information associated with an advertising impression location where the extracted search listing is displayed. Also, the advertising field 211 is a unit for embodying display of the search listing in the specified search engine 110. That is, the advertising field 211 includes identification information about the search engine 110 where the search listing is displayed and maintains keyword information causing extraction of the search listing and ranking information associated with the advertising impression location. At this time, the search engine 110 is a kind of advertising medium. Thus, the search engine 110 enables the search listing associated with the advertiser 130 to be displayed to the searcher 120 as search results, thereby causing advertising effects. The advertising fields 211 are set up such that search listings to be extracted on the basis of disposition (a region, an age, and a sex) of the searcher 120 accessing the search engine 110 are different respectively, thereby enhancing advertising effects. Also, the advertising field 211 determines ranking information about the optimal advertising impression location of the search listing, corresponding to the set advertising costs, by considering access connection frequency of the searcher 120 for an advertising impression location of the search listing and unit click cost.

The advertising group 212 is a unit for associating at least one advertising field 211 and recording advertising duration information about a period for which a search listing is displayed. That is, the advertising group 212 is for controlling a time band for which the search listing is displayed on an advertising medium. For example, the advertising group 212 controls information on a starting date when impression of the search listing starts and a closing date when it ends, a time band of impression allowed during a day, and the like. Particularly, the advertising group 212 further includes selection information (ON/OFF) in association with display of the search listing. For example, in case that the advertiser 130 does not allow display of the search listing, in other words, in case that the advertiser 130 selects OFF, the advertising group 212 can control extraction of a search listing by the advertising field 211 associated with the advertising group 212 to be stopped. That is, the advertising group 212 can collectively control starting or stopping of advertising for all the subordinate advertising fields 211. Through this, hierarchical advertising management can be embodied.

The campaign 213 is a unit for associating at least one advertising group 212 and recording selection information about an impression target to which a search listing is displayed. That is, the campaign 213 serves to specify a target to which the search listing has to be impressed, by considering the purpose of advertising that the advertiser 130 wants to accomplish, estimated advertising effects, and the like. At this time, the selection information includes information on a region of the impression target, an age thereof, a sex thereof, a channel thereof, and the like. Also, the campaign 213 enables the search listing of the advertiser 130 to be selectively displayed based on a region of the searcher 120, an age thereof, and a sex thereof. Particularly, the channel specified by the campaign 213 is for further dividing a field of the search engine displaying the search listing. For example, the campaign 213 enables specification with respect to a partner site, such as an Internet search engine (portal site), an e-commerce server, a community server, and the like. In the present embodiment, while specification of the advertising media by the channel is limited to the online advertising media, this is only for convenience of description. Thus, it is possible to specify the offline advertising media, such as the mass media, the printed media, the event sponsor media, and the like. The channel specified by the campaign 213 influences the subordinate advertising groups 212 or advertising fields 213. The search engine 212 displaying the search listing is limited to a predetermined online advertising medium corresponding to the channel. For example, in case that the channel specified by the campaign 213 is limited to the Internet search server, a search listing extracted by the advertising field 211 can be controlled to be displayed only in ‘an naver search engine’, ‘a knowledge iN search engine’, and the like, which is a kind of Internet search servers.

The advertiser account 214 is a unit for associating at least one campaign 213 and recording billing information associated with display of the search listing. That is, the advertiser account 214 includes login information of the advertiser 130 and payment information thereof. Also, the advertiser account 214 enables a bill to be paid through identification of login of the advertiser 130 with respect to advertising costs executed in the campaigns 213, the advertising groups 212, and the advertising fields 211, which are under the control of the advertiser account 214. Payment information recorded in the advertiser account 214 is associated with budget information which can be used in lower unit hierarchies. Also, the payment information can be allocated to each of the campaigns 213 or each of unit hierarchies, at a predetermined rate, in accordance with a selection of the advertiser 130.

The impression management system 100 of the present invention systematically manages display of a search listing of the advertiser 130 at the particular search engine 110 in accordance with an advertising condition which is included in each of unit hierarchies. Also, the impression management system 100 reflects any change of the advertising condition of a higher unit hierarchy into that of a lower unit hierarchy, thereby enabling attribute of advertising to be collectively adjusted.

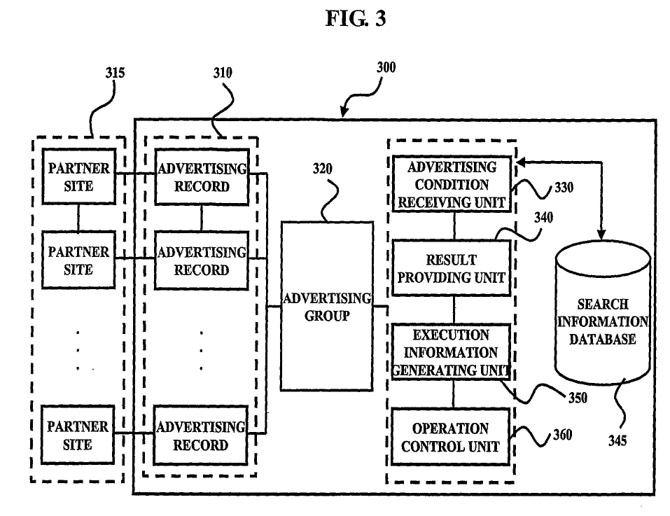

Hereinafter, configuration of an impression management system 300 of the present invention will be described with reference to FIG. 3.

FIG. 3 is a configuration diagram illustrating an impressing management system according to a preferred embodiment of the present invention.

The impression management system 300 of the present invention includes advertising records 310, an advertising group 320, an advertising condition receiving unit 330, a result providing unit 340, an execution information generating unit 350, and an operation control unit 360.

First, the advertising record 310 is a unit for recording impression information associated with display of a search listing. Thus, the advertising record 310 maintains procedures of displaying the search listing which is brief information about the advertiser 130 to the searcher 120, for example, impression information about extraction of the search listing, display thereof at the search engine 110, and specification thereof 110 where the search listing is displayed. The impression information can be set up by the advertiser 130 under a predetermined contract. Thus, an advertising condition to display the search listing can be actively controlled by the advertiser 130. Particularly, impression information of the present embodiment includes information on a display time band of the search listing, information on an impression target thereof, and information on the allowed number of clicks of the searcher 120. Further detailed control for display of the search listing is enabled.

At this time, the information on a display time band is for limiting a time for which a search listing extracted in response to a search request is displayed. Thus, the information on a display time band is used when the advertiser 130 strategically wants to limit a time for which the search listing is displayed. For example, in case that the advertiser 130 wants to stop impression of the search listing at midnight between 0 and 4 hours, he/she 130 can specify the display time band to be ‘from 4 to 24 hours’ and store the specified display time band. Display of the search listing is stopped by a search request generating at the midnight.

Also, the information on an impression target of the search listing is for limiting the searcher 120 to which the search listing is displayed. Thus, the information on an impression target of the search listing is used when an impression target of the search listing is limited on the basis of a region of the searcher 120, an age thereof, and a sex thereof. Identification of the searcher 120 to which the search listing is based on personal information of the searcher 120 recognized through an authenticating process. The impression target of the search listing is particularly limited by marketing strategies of the advertiser 130. For example, in case that females in 20s who live in the metropolitan area become a target of the search listing, the advertiser 130 thereof specifies an impression target to which the search listing is displayed based on personal information such as address information of the searcher 120, birthday information thereof, and sex information. Thus, the search listing is not displayed to other searchers 120, such as for example, male searchers.

Also, the information on the allowed number of clicks is for limiting advertising costs charged to the advertiser 130 by a selection of the searcher 120 with respect to the search listing. For example, advertising costs executed by each channel (search engine 110) can be limited not to exceed the set advertising budget. This is because one-time advertising costs are computed based on a unit click cost included in a particular search listing, as the searcher 120 selects the same. That is, the advertiser 130 determines the allowed number of clicks which are estimated to generate at a particular channel during a predetermined period, by considering advertising budget allocated to the channel. The advertiser 130 inputs the determined allowed number of clicks as impression information. Besides this, the allowed number of clicks can be set up based on the number of products that the advertiser 130 sells or ratio of the number of clicks through which actual purchase is completed. For example, in case that the number of products that the advertiser 130 sells is 100 and a ratio of the number of clicks getting to actual purchase is 10%, the allowed number of clicks can be set up as 1,000 (=100/0.1).

The advertising group 320 is a unit for associating at least one advertising record 310. For example, the advertising group 320 is formed by grouping the advertising records 310 maintaining a search listing of the advertiser 130 as impression information. The number of the advertising groups 320 associating the advertising records 310 may be one for each advertiser 130. Or, a plurality of advertising groups 320 can be determined for one advertiser 130 by considering a kind of products for which an advertising act is performed (for example, a SAMSUNG refrigerator, and a SAMSUNG camera), the purpose of advertising (for example, SAMSUNG's special discount), and the like.

The advertising condition receiving unit 330 is a unit for recording a predetermined advertising closing condition in the advertising group 320. Thus, the advertising condition receiving unit 330 serves to record a predetermined limited advertising condition such that display of the search listing is controlled at each of the partner sites 315 as for intention of the advertiser 130. At this time, the advertising closing condition may be data of the limited number of clicks or budget data allocated to the advertising group 320. Also, the advertising closing condition may be a limited condition enabling stoppage of advertising (cutting off display of the search listing) when the total number of unit clicks generating or the accumulated amount of advertising costs executed at the advertising record 310 associated with the advertising group reaches the set budget data or data of the limited number of clicks. The advertising closing condition can be inputted by the advertiser 130 because of marketing strategies. The advertising condition receiving unit 330 maintains the inputted advertising closing condition for each advertising group 320. Also, the advertising condition receiving unit 330 can record the advertising closing condition for each advertising record 320. Also, the advertising condition receiving unit 330 enables particular one advertising record 310 satisfying the advertising closing condition to be stopped, thereby enabling advertising management based on both the advertising group 320 and the advertising record 310.

The result providing unit 340 is a unit for providing the searcher 120 with a search listing based on impression information, in response to a search request of the searcher 120. That is, the result providing unit 340 serves to identify the partner site 315 where a search request generates, and to recognize the advertising record 310 maintaining a keyword inputted for a search request as impression information from the advertising records 310 associated with the identified partner site 315. As aforementioned, impression information of the advertising record 310 includes information on a keyword causing extraction. Thus, the result providing unit 340 extracts a search listing corresponding to the inputted keyword from the search information database 345 by referring to the recognized advertising record 310.

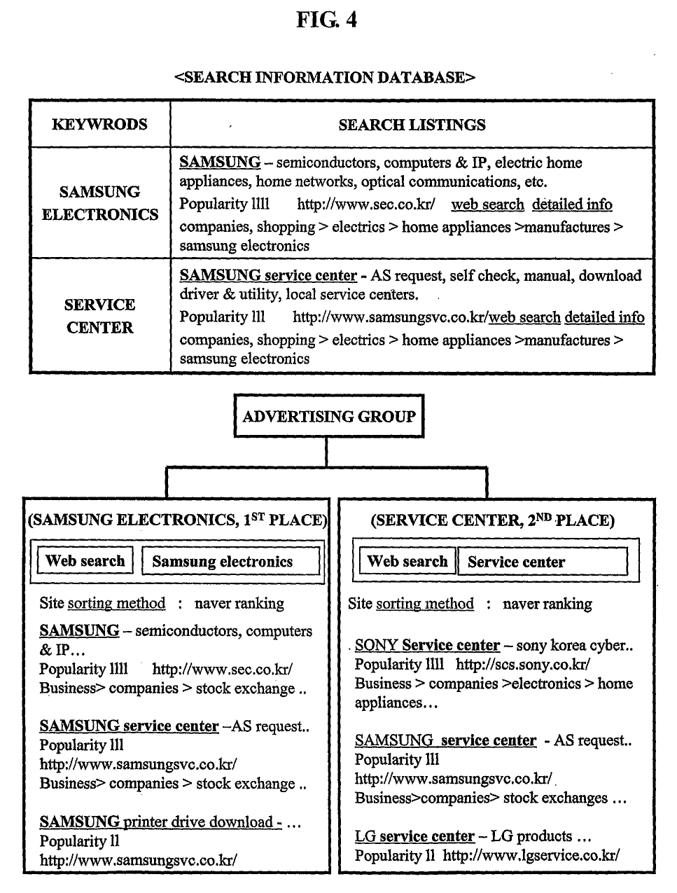

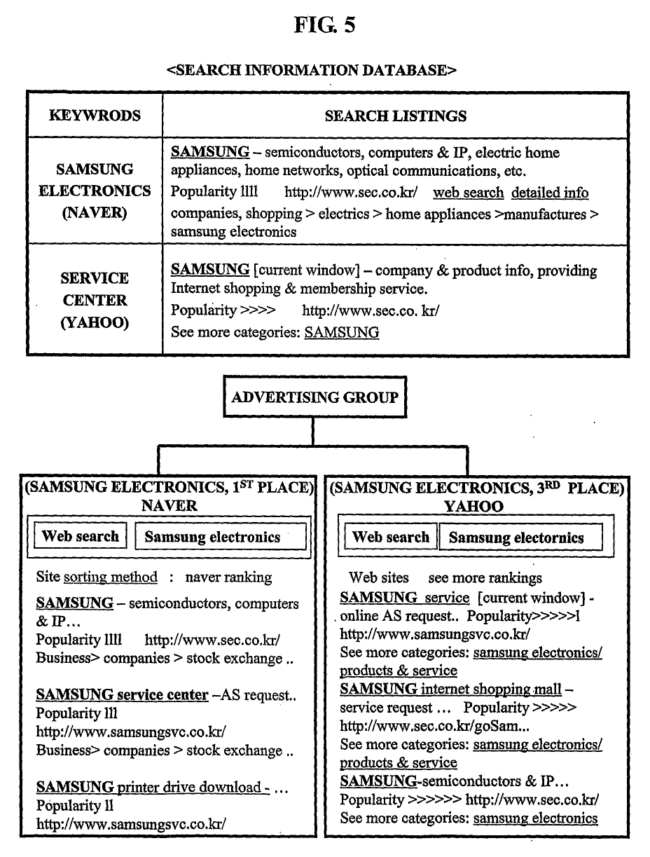

FIGS. 4 and 5 are diagrams illustrating search listings extracted to each of partner sites according to the present invention. In FIG. 4, a plurality of search listings are displayed in the same partner site 315, and in FIG. 5, respectively different search listings which are generated suitable for each of partner sites 315 are displayed in a plurality of partner sites 315.

First, in FIG. 4, the search information database 315 maintains search listings corresponding to keywords, ‘samsung electronics’ and ‘service center’, respectively. Impression information of ‘samsung electronics, ranking a first place’ and ‘service center, ranking a second place’, respectively, is included in a plurality of advertising records 310 associated with the adverting group 320. For example, in case that all the channel information about the advertising records 310 is ‘naver’ and the searcher 120 inputs keyword ‘samsung electronics’ into the search engine ‘naver’ to generate a search request, the result providing unit 340 extracts a search listing corresponding to the keyword ‘samsung electronics’ from the search information database 345. Also, the search information database 345 enables the extracted search listing to be displayed in ‘a first place’ of the advertising impression location on a search screen, as illustrated in FIG. 4. At this time, the advertising record 310 includes information on a unit click cost in order to display the search listing in the advertising impression location specified in the impression information. At this time, the unit click cost can be recorded, such that an optimal cost value is automatically set up by receiving a random cost value from the advertiser 130 or by comparing a unit click cost of another search listing displayed by the same keyword. The optimal cost value enables the search listing of the advertiser 130 to be displayed at a corresponding advertising impression location. The unit click cost such configured does not change while the search listing is displayed at a particular advertising impression location. In case that the search listing cannot be displayed at the advertising impression location because of another search listing, i.e. in case that another search listing has a higher unit click cost, the result providing unit 340 stops the advertising record 310 from extracting a search listing or controls notice information to be provided to the advertiser 130. The notice information is associated with input of updating of a unit click cost. Likewise, when the keyword ‘service center’ is inputted by the searcher 120, the result providing unit 340 extracts a search listing corresponding to the keyword ‘service center’ and displays the extracted search listing in a ‘second place’ of advertising impression locations on the search screen.

Also, in FIG. 5, the search information database 345 maintains search listings prepared on the basis of system environments of the partner site 315 and keywords causing the prepared search listings to be extracted. For example, it is assumed that channel information of the advertising records 310 associated with the advertising group 320 are ‘naver’ and ‘yahoo’, respectively, and ‘samsung electronics, ranking a first place’ and ‘samsung electronics, ranking a third place’ are included as impression information of the advertising records 310, respectively. In case that the searcher 120 inputs ‘samsung electronics’ into the search engine ‘yahoo’ to request a search, the result providing unit 340 extracts a search listing for yahoo from the search information database 345 and displays the extracted search listing in a ‘third place’ of advertising impression locations on the search screen. It is shown in FIG. 5.

Accordingly, the result providing unit 340 enables a particular search listing wanted by the advertiser 130 to be displayed at a particular advertising impression location, in response to a search request generated at a plurality of partner sites 315.

The execution information generating unit 350 is a unit for receiving a selection of the searcher 120 with respect to the provided search listing and recoding advertising execution information generated in association with the selection in the advertising group 320. At this time, the advertising execution information may be accumulated cost information about a billing amount generating by a selection of the searcher 120 with respect to the search listing. Also, the advertising execution information may be the accumulated number of clicks with respect to clicks generating by a selection of the searcher 120 with respect to the search listing. That is, the execution information generating unit 350 generates advertising execution information based on a unit click cost generating by the number of valid clicks which actually connect the searcher 120 to the advertiser 130, in association with display of the search listing at the partner site 315. The generated advertising execution information is periodically updated for a predetermined advertising period and recorded in the advertising group 320.

The operation control unit 360 is a unit for comparing the recorded advertising execution information and advertising closing information and stopping providing of a search listing by the advertising record 310 associated with the advertising group 320, when the recorded execution information satisfies the advertising closing. That is, the operation control unit 360 determines whether the accumulated cost information reaches budget data, or whether the information on the accumulated number of clicks reaches data of the limited number of clicks. At this time, in case that it is determined that any one of advertising execution information reaches the advertising closing condition, the operation control unit 360 controls all the advertising acts by the advertising group 320 to be stopped. This is not to allow any more advertising act (display of the search listing) when the advertiser 130 determines that enough advertising effects or sales of products have been accomplished. Thus, there is an effect that advertising can be managed such that intention of the advertiser 130 is reflected to the most.

Also, the impression management system 300 of the present invention displays the extracted search listing in the predetermined advertising impression location, based on ranking information included in the advertising record 310. Also, the impression management system 300 enables extraction/display of the search listing to be performed on the basis of a unit click cost of the search listing and CTR thereof That is, the impression management system 300 adopts various statistical factors and bidding methods to search listings, thereby enabling extraction/display thereof. Thus, it is possible to solve a problem, such as for example, continuous increase in advertising costs, in which the problem is caused by extracting/displaying search listings simply on the basis of the size of unit click cost.

First, the bidding method is for dividing an impression area on the search screen where search listings will be displayed into unit display zones and enabling an individual bid to be made for each of unit display zones. For example, a bid is made using the unit click cost included in the advertising record 310. The unit display zone is an individual impression area where one search listing is displayed, and a location where the searcher 120 can easily recognize can be divided into unit display zones. For example, the first ranking advertising impression location can be provided from the highest portion of the search screen. Thus, the result providing unit 340 can control the extracted search listing to be displayed at the unit display zone only in case that the unit click cost associated with the search listing reaches the maximum amount, through a bidding process for the unit display zone in the advertising impression location specified by impression information of the advertising record 310.

For example, in case of a search listing whose ranking information is ‘a second place’ and unit click cost is ‘500 won’, when unit click costs of other search listings making a bid for a unit display zone whose recognition is second highest among the searchers 120 (a unit display zone located in the second place on the search screen) are below 500 won, the search listing can be displayed at the specified unit displayed zone in response to a search request. That is, in the bidding method, one search listing maintaining the highest unit click cost is displayed at the unit display zone of the ‘second ranking’ advertising impression location, among search listings making a bid for the unit display zone.

Also, as another embodiment, the result providing unit 340 may also consider that a unit click cost required to display an extracted search listing in a specified unit display zone is flexibly adjusted/changed. For example, in the previous embodiment, when the unit click cost of another search listing exceeds ‘550 won’, the result providing unit 350 can maintain display of the search listing in the unit display zone, in such a manner that the early unit click cost ‘500 won’ is controlled to be changed into ‘600 won’ automatically.

Meanwhile, the result providing unit 340 can perform display or extraction of the search listing, based on information on the unit click cost included in the advertising record 310 and CTR for the search listing of impression information computed for a predetermined period. This is to perform extraction/display of the search listing by considering the unit click cost and popularity of the search listing, irrespective of ranking information included in impression information of the advertising record 310. For example, in a specific embodiment, a priority order in which the search listing is extracted and the advertising impression location can be determined on the basis of computation of the unit click cost and CTR and comparison of the computed values. For example, the search listing whose CTR is ‘0.7’ and unit click cost is ‘500 won’ has a value of ‘350’ through the computation. In case that all the computed values of other search listings corresponding to the same keyword is below ‘350’, the search listing having a value of ‘350’ can be extracted first and determined to be displayed at the ‘first place’ of the advertising impression location which is well recognizable.

Operations of the impression management system 300 such configured according to the present invention will be fully described.

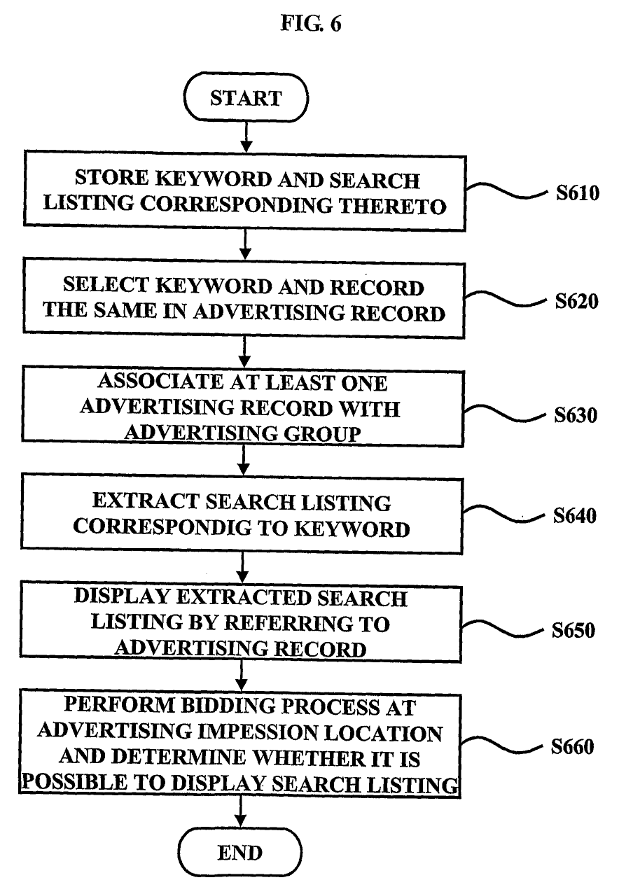

FIG. 6 is a flowchart illustrating a method for managing an impression of a search listing according to a preferred embodiment of the present invention.

The impression management method according to the present embodiment is performed by the aforementioned impression management system 300.

First, the impression management system 300 maintains the search information database 345 for storing a keyword and a search listing corresponding thereto (S610). This step S610 is a procedure for storing a search listing associated with the advertiser 130 and a keyword causing extraction of the search listing. The keyword is inputted and stored by the advertiser 130 considering marketing strategies such as an impression target to which his/her (company) search listing is displayed (see FIGS. 4 and 5). In the present embodiment, while the number of keywords corresponding to one search listing is not particularly limited, it may be preferable that one keyword corresponds to one search listing in order to protect benefits of keyword advertising. Also, it is possible to make a category representing a plurality of keywords correspond to one search listing. In this case, the search listing of the advertiser 130 can be more frequently extracted/displayed through input of various keywords.

Also, the impression management system 300 selects the predetermined number of keywords from the stored keywords and records the selected keywords in the advertising records 310, respectively (S620). This step S620 is a procedure for storing a keyword in the advertising record 310 associated with display of a search listing, as impression information. Thus, the keyword can be selected from keywords stored in the search information database 345 and recorded in the advertising record 310. The number of keywords to be recorded in the advertising records 310 is not particularly limited in the present embodiment. For convenience of description, one selected keyword is inputted in the advertising record 310.

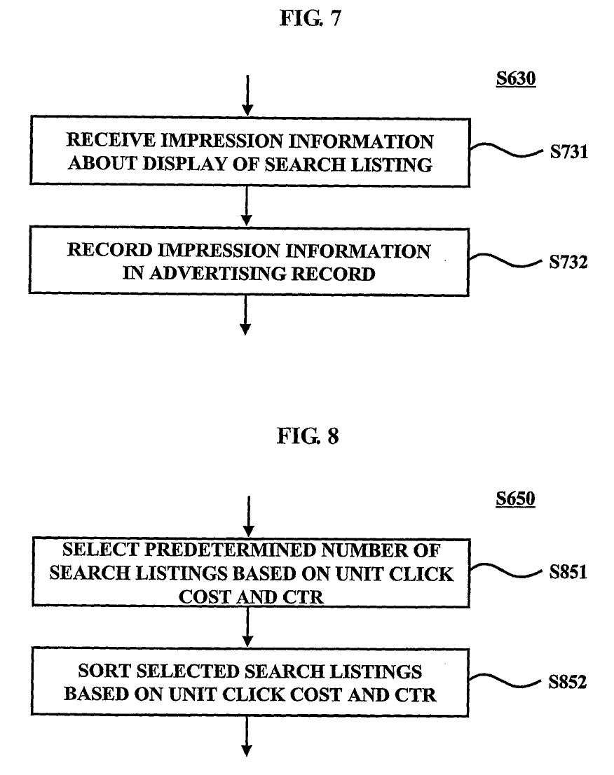

In the next, the impression management system 300 associates at least one advertising record 310 with the advertising group 320 (S630). This step S630 is a procedure for grouping the advertising records 310 maintaining information on a search listing associated with the same advertiser 130 as impression information. Through this, hierarchical advertising management is enabled with respect to search listings associated with the particular advertiser 130. Hereinafter, associating the advertising group 320 with the advertising record 310 will be described with reference to FIGS. 7 to 9.

FIG. 7 is a flowchart illustrating one example of a method for associating an advertising group according to the present invention.

As illustrated in FIG. 7, the impression management system 300 receives impression information about display of a search listing (S731). This step S731 is a procedure for receiving reference data limiting an impression target to which the search listing of the advertiser 130 is displayed. In this step, the search listing is displayed only to the searcher 120 corresponding to marketing strategies of the advertiser 130. Impression information may include information on a display time band of the search listing, information on an impression target thereof, and information on the number of clicks of the searcher 120 with respect to the search listing. Detailed description related thereto will be same to the aforementioned and omitted here. At this time, the impression information can be changed/updated frequently in accordance with any change in marketing strategies of the advertiser 130. Through this, it is possible to cope with a flexible marketing market and to manage advertising.

Also, the impression management system 300 records the received impression information in each advertising record 310 associated with a corresponding search listing (S732). This step S732 is a procedure for recording the received impression information in the advertising records 310 grouped into one advertising group 320. In this step, when one piece of impression information is inputted, the impression information is totally applied to all the advertising records 310 associated with the advertising group 320.

Thus, according to the present invention, it is possible to limit an impression target of a search listing for intention of the advertiser 130 in order to enhance advertising effects. Also, according to the present invention, it is possible to collectively record impression information about one advertising record 310 associated with display of the search listing at a plurality of search engines 110 by using the advertising group 320 unit. Thus, there is an effect that the purpose of the present invention for embodiment of advertising management can be faithfully performed.

Referring to FIG. 6 again, the impression management system 300 extracts a search listing corresponding to a keyword inputted for a search request by referring to the search information database 345 (S640). This step S640 is a procedure for recognizing the search listing as search results, in response to the search request. In this step S640, a search listing corresponding to the inputted keyword is extracted. Particularly, in this step, the impression management system 300 can perform the procedure of identifying the advertising record 310 maintaining channel information associated with the search engine 110 which has generated the search request. This is to extract the search listing specified by each search engine 110 that the searcher 120 uses. Thus, it is possible to enable extraction/display of a differentiated search listing of the advertiser 130 by considering disposition (for example, a region, an age, a sex, etc) of the searcher 120 accessing the search engine 110. Through this, it is possible to enhance advertising effects.

Also, the impression management system 300 controls the extracted search listing to be displayed by referring to the advertising record 310 associated with the inputted keyword (S650). This step S650 is a procedure for providing the search listing extracted by the identified advertising record 310 to the search engine 110 where the search request has been generated, in order to display the provided search listing to the searcher 120. At this time, a location of the search listing displayed to the searcher 120 is limited to an advertising impression location demanded by the advertiser 130. For this, ranking information specifying the advertising impression location is included in the search information database 310. The ranking information is received from the advertiser 130, considering advertising costs generating when each advertising record 310 extracts a search listing, or advertising effects which are estimated to generate in accordance with an advertising impression location.

That is, the impression management system 300 performs a predetermined bidding process at the advertising impression location and determines whether it is possible to display the extracted search listing (S660). At this time, the bidding process is to determine whether the extracted search listing can be displayed at the advertising impression location wanted by the advertiser 130. As aforementioned, the bidding process can be divided into a method of comparing the size of the unit click cost for each advertising impression location and a method of determining an extracted order/advertising impression location based on the unit click cost and CTR.

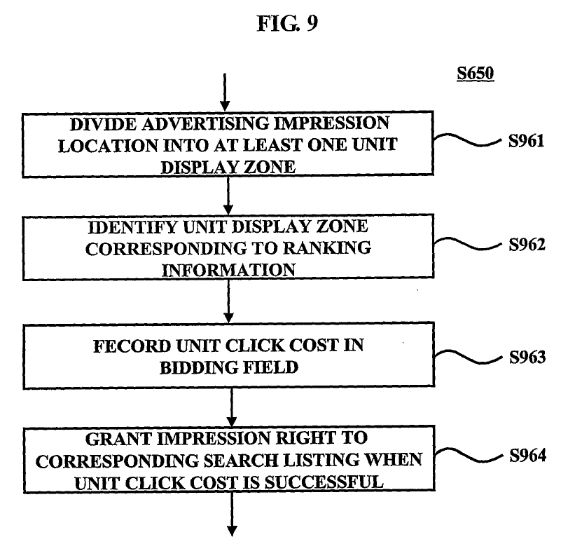

Hereinafter, a bidding process according to the present embodiment will be fully described with reference to FIGS. 8 and 9.

FIG. 8 is a flowchart illustrating one example of a method for performing a bidding process based on a unit click cost and click through rate (CTR) according to the present invention.

As illustrated in FIG. 8, the impression management system 300 selects the predetermined number of search listings from one or more search listings extracted in correspondence to a keyword inputted for a search request, based on a first click cost and CTR (S851). For this, the advertising record 310 includes information on the first unit click cost and CTR associated with display of the extracted search listing. The impression management system 300 computes the first unit click cost and CTR, and extracts/displays search listings sequentially in order of the computed numerical values. That is, in this step S851, when extracting/displaying search listings, the impression management system 300 determines the extraction order of the search listing and the advertising impression location thereof on the basis of both the unit click cost about profitability of advertising and CTR about popularity of the search listing. At this time, the first unit click cost is the maximum allowable advertising costs generating by a selection of the searcher 120. The CTR is a ratio of the number of times that the searcher 120 is actually connected to the advertiser 130 to the number of times that the search listing is displayed for a predetermined previous time. Also, the number of search listings to be extracted can be flexibly determined by the system operator considering the area of the search screen where the search listings will be displayed.

Also, the impression management system 300 sorts the selected search listings based on the first unit click cost and CTR (S852). This step S852 is a procedure for sorting search listings extracted based on the computed numerical values in a state where the search screen is being indicated. For example, in this step, the search listing having the highest numerical value is provided in the highest portion of the search screen which is well recognizable. Thus, when extracting search listings, the impression management system 300 enables the search listing of the advertiser 130 who is willing to pay higher advertising costs or the search listing having higher CTR because of previous popularity to be preferentially displayed to the searcher 120.

Also, it may be preferable that the number of search listings to be extracted/displayed is same to the number of search listings maintained in the search information database 345 in correspondence to a keyword or channel information. This is to bring more advertising benefits to the system operator by extracting the maximum number of search listings corresponding to the keyword.

Accordingly, search listings can be displayed in such a manner that the predetermined number of search listings is extracted based on computation of the unit click cost and CTR and advertising impression locations thereof are determined. Thus, it is possible to display the search listing reflecting its beneficial effects and popularity of a web site of the advertiser 130 associated with the search listing.

FIG. 9 is a flowchart illustrating one example of a method for determining a search listing to be displayed by a bidding method at a particular advertising impression location.

As illustrated in FIG. 9, the impression management system 300 divides an advertising impression location into at lest one unit display zone (S961). This step S961 is a procedure for determining where to locate an extracted search listing in response to an inputted keyword of the searcher 120 on a search screen. For example, in this step, the predetermined number of unit display zones is defined from the highest portion of the searcher screen by a location defining unit (not illustrated), based on the number of generated clicks. Dividing the advertising impression location into the unit display zones is for making an independent bid for each unit display zone and displaying the search listing of the advertiser 130 only at the advertising impression location wanted by the advertiser 130.

Also, the impression management system 300 identifies a unit display zone corresponding to ranking information from the divided unit display zones (S962). This step S962 is a procedure for granting ranking information to the divided unit display zone in accordance with a selected criterion and determining a location to display the search listing in accordance with intention of the advertiser 130. The criterion to grant the ranking can be flexibly determined by the system operator. For example, rankings are granted to each of unit display zones, in accordance with frequency of selections of the searcher 120 with respect to the unit display zone for a predetermined previous period. For example, in case that ranking information is ‘ranking a second place’, the unit display zone specified by the advertiser 130 can be identified as the second unit display zone from a higher portion of the search screen.

In the next, the impression management system 300 records the first unit click cost in a predetermined bidding filed associated with the identified unit display zone (S963). This step S963 is a procedure for additionally storing a unit click cost in the bidding field associated with the advertising impression location, in response to input of the unit click cost into the advertising record 310. A second unit click cost of another search listing can be recorded in the bidding field. The another search listing is associated with its display at the advertising impression location. The impression management system 300 performs a bidding process for comparing the size between the newly inputted first unit click cost and the previously recorded second unit click cost, thereby determining any one as a successful unit click cost.

Also, in case that it is determined that the first unit click cost is successful by the bidding process in the bidding field, an impression right at the identified unit display zone is granted to a search listing associated with the successful first unit click cost (S964). This step S964 is a procedure for displaying the search listing of the first unit click cost at the unit display zone when it is determined that the first unit click cost associated with the search listing of the advertiser 130 has the highest numerical value among unit click costs recorded in the bidding field. That is, the impression management system 300 performs the bidding process in interoperation with recording the first unit click cost in the bidding field. The unit click cost having the highest numerical value recorded in the bidding field is determined to be successful and the impression right at the unit display zone is granted thereto.

Thus, according to the present invention, there is an effect that a search listing can be displayed only at an advertising impression location wanted by the advertiser 130 through bidding process with respect to a specified unit display zone.

As another embodiment of the present invention, limiting an impression target to which a search listing is displayed will be described using impression information recorded in the advertising record 310.

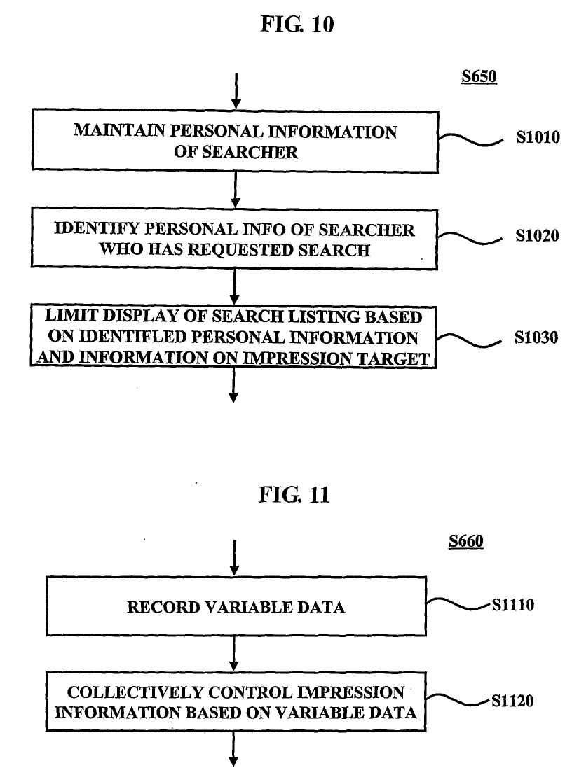

FIG. 10 is a flowchart illustrating one example of a method for confining an impression target of a search listing according to the present invention.

The present embodiment can be performed in the step S650 controlling the search listing to be displayed. As illustrated in FIG. 10, the impression management system 300 maintains personal information for authenticating the searcher 120 (S1010). This step S1010 is a procedure for recording personal information required to enable the searcher 120 to log in the search engine 110 under a predetermined contract. Thus, in this step, personal information of the searcher 120, such as for example, a name, an address, an age, a sex, a phone number, etc, is received from the searcher 120. The received personal information is recorded in a predetermined user information database (not illustrated).

Also, the impression management system 300 identifies personal information of the searcher 120 when the searcher 120 requests a search (S1020). This step S1020 is a procedure for obtaining information associated with the searcher 120 inputting a keyword. In this step, information on the searcher 120 is identified to be compared with information on an impression target. At this time, information on the impression target is reference information to specify the searcher 120 to which display of the search listing is allowed, such as for example, region information, age information and sex information.

In the next, the impression management system 300 compares the identified personal information and the information on the impression target, and confines display of the search listing based on at least one of regional information of the searcher 120, age information thereof, and sex information thereof (S1030). This step S1030 is a procedure for displaying the search listing only to the searcher 120 who is allowed as an impression target on the basis of the identified personal information of the searcher 120.

Thus, according to the present invention, since the search listing of the advertiser 130 is selectively displayed based on a region of the searcher 120, an age thereof, and a sex thereof, there is an effect that it is possible to generate advertising effects most suitable for marketing strategies of the advertiser 130.

As another embodiment of the present invention, it will be described that impression information of the advertising record 310 associated with the advertising group 320 is collectively changed.

FIG. 11 is a flowchart illustrating one example of a method for changing attribute of an advertising record according to the present invention.

First, the impression management system 300 records variable data in the advertising group 320 (S1110). This step S1110 is a procedure for receiving variable data from the advertiser 130 when any variable element about impression information stored in each advertising record 310 generates, and storing the received information data in the advertising group 320. At this time, the variable data is for changing a portion of or the entire impression information for marketing strategies of the advertiser 130. Impression information changed by the variable data may be a region of the searcher 120, an age thereof, a sex thereof, or a display time band of the search listing.

Also, the impression management system 300 collectively controls impression information about at least one portion of the advertising records 310 associated with the advertising group 320, based on the recorded variable data (S1120). This step S1120 is a procedure for enabling attribute of impression information to be changed collectively with respect to all the advertising records 310, not with respect to the individual advertising record 310. For example, in case that variable data inputted by the advertiser 130 is about changing an age of the searcher 120 for an impression target into ‘20s’, the impression management system 300 can collectively change age information of impression information of the advertising records 310 maintaining age information besides ‘20s’ as existing impression information, into ‘20s’.

Thus, according to the present invention, there is an effect that it is possible to faithfully perform the purpose of the present invention for collective control with respect to the advertising records 310 associated with the advertising group 320.

Also, the present invention adopts a billing method based on CPC (cost per click) generating advertising costs per selection of the searcher 120 with respect to the displayed search listing. For this, the advertising record 310 of the present invention includes unit click cost information.

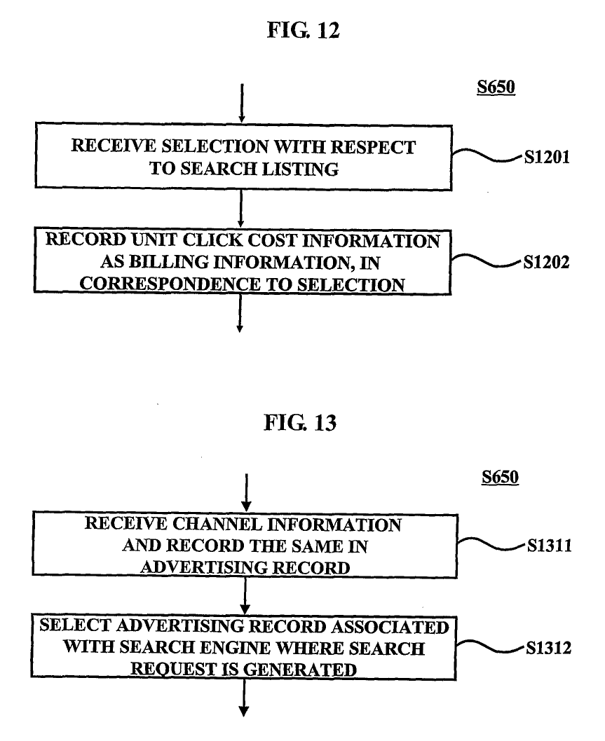

FIG. 12 is a flowchart illustrating one example of a method for computing advertising costs according to the present invention. The present embodiment can be performed in the step S650 displaying the extracted search listing.

As illustrated in FIG. 12, the impression management system 300 receives a selection of the searcher 120 with respect to a search listing displayed at an advertising impression location (S1201). This step S1201 is a procedure for recognizing a search listing that the searcher 120 demands to be connected among search listings displayed as search results. For example, in this step, the impression management system 300 confirms a selection for a valid click only which has connected the actual searcher 120 to the advertiser 130. This is to exactly compute advertising costs of the search listing. Thus, a selection is received only with respect to clicks generating actual advertising effects.

Also, the impression management system 300 records unit click cost information in the advertising group 320 as billing information, in correspondence to a selection (S1202). This step S1202 is a procedure for embodying a billing method based on CPC. Thus, in this step, a unit click cost associated with a search listing is used to compute advertising costs in accordance with a selection of the searcher 120 with respect to the search listing. Also, the computed advertising costs are accumulated for a predetermined period. The impression management system 300 controls the accumulated advertising costs to be charged to the advertiser 130 at a predetermined point of time.

Thus, according to the present invention, since advertising costs are charged based on a selection of the searcher 120 with respect to the displayed search listing, there is an effect that more reasonable payment is possible and it is also possible to bring economic and efficient advertising effects to the advertiser 130.

Also, according to the present invention, information on the partner sites 315 is recorded in the advertising records 310, respectively. Also, the search listing of the advertiser 130 is limited to be displayed in a particular partner site. Thus, an optimal advertising act for the searcher 120 is enabled by displaying a respectively different search listing of the advertiser 130 for each partner site 315.

FIG. 13 is a flowchart illustrating one example of a method for specifying a partner site on which a search listing is displayed. The present embodiment can be performed in the step S650 displaying the extracted search listing.

First, the impression management system 300 receives channel information associated with the search engine 110 and records the received channel information in the advertising record 310 (S1311). This step S1311 is a procedure for receiving information on the partner site 315 on which the search listing is displayed, for example, from the advertiser 130, and storing the received channel information in the particular advertising record 310 which involves in extracting the search listing. That is, in this step S1311, the impression management system 300 determines the partner site 315 on which the extracted search listing is displayed. The channel information includes a network address, such as for example, a URL, an IP address, a domain, and the like.

Also, the impression management system 300 recognizes the search engine 110 at which a search request is generated, and identifies the advertising record 310 recording channel information of the recognized search engine 110 (S1312). This step S1312 is a procedure for checking the advertising record 310 maintaining the partner site 315 at which a search request is generated by the searcher 120 as channel information. In this step, the impression management system 300 provides the searcher 120 with the advertiser 130's search listing corresponding to a keyword on the search engine 110 providing a search service, as search results.

Thus, according to the present invention, it is possible to display a search listing most suitable for marketing strategies of the advertiser 130 by enabling a search listing to be displayed at the partner site 315 to be determined for intention of the advertiser 130.

Hereinafter, as another embodiment of the present invention, it will be described that display of a search listing is stopped at an associated advertising record when advertising execution information generated at an advertising group satisfies a predetermined advertising closing condition.

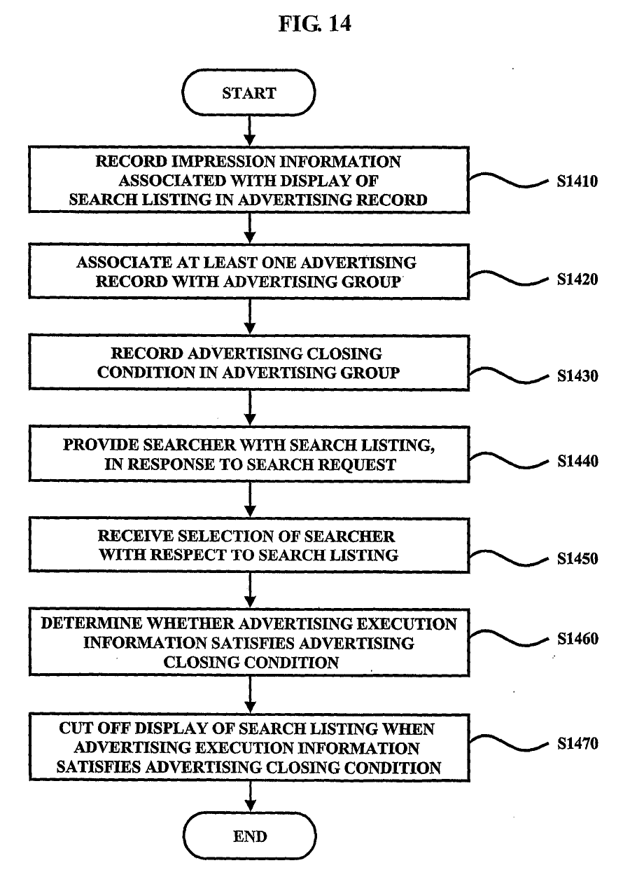

FIG. 14 is a flowchart illustrating an impression management method for cutting off extraction of a search listing based on an advertising closing condition according to the present invention.

First, the impression management system 300 records impression information associated with display of a search listing in the predetermined advertising record 310 (S1410). The impression management system 300 associates at least one advertising record 310 with the advertising group 320 (S1420). These steps S1410 and S1420 are procedures for grouping the advertising records 310 maintaining impression information about the search listing of the same advertiser 130. Detailed description related thereto will be same to the aforementioned steps S620 and S630. Thus, it will be omitted here.

Also, the impression management system 300 records a predetermined advertising closing condition in the advertising group 320 (S1430). This step S1430 is a procedure for receiving advertising closing condition information from the advertiser 130. At this time, the advertising closing condition information is for limiting a period for which the search listing is displayed by the advertising record 310 in accordance with the advertiser 130's marketing strategies. The advertising closing condition may be data of the limited number of clicks or budget data allocated to the advertising group 320. Also, the advertising closing condition serves to set a limit on accumulated costs for a billing amount or the accumulated number of clicks with respect to clicks which generate within the advertising group 320. That is, the advertising closing condition may be received from the advertiser 130 considering allowable advertising costs, the quantity of products that the advertiser 130 plans to sell, a ratio of clicks being connected to actual purchase, and the like. A display closing time of the search listing that the advertiser 130 wants is recognized by the impression management system 300.

In the next, the impression management system 300 provides the searcher 120 with a predetermined search listing based on impression information, in response to a search request of the searcher 120 (S1440). The impression management system 300 receives a selection of the searcher 120 with respect to the provided search listing (S1450). These steps S1440 and S1450 are procedures for displaying search listings of the advertisers 130 on the search engine 110 at which the searcher 120 inputs a keyword, as search results, and confirming a selection of the searcher 120 with respect to a particular search listing. Particularly, in these steps, the impression management system 300 records advertising execution information generated in association with a selection of the searcher 120, in the advertising group 320. At this time, the advertising execution information may be accumulated cost information about a billing amount generating by a selection of the searcher 120 with respect to the search listing, or information on the accumulated number of clicks with respect to clicks generating by a selection. That is, the advertising execution information is for identifying a state of advertising costs generating by a selection of the searcher with respect to the search listing of the advertiser 130. Through this, it is determined whether advertising budget or the limited number of clicks set by the advertiser 130 as the advertising closing condition is approached.

In the next, the impression management system 300 determines whether the recorded advertising execution information satisfies the advertising closing condition (S1460). This step S1460 is a procedure for determining whether accumulated cost information reaches budget data. The accumulated cost information and the budget data are advertising execution information. In this step, it is determined whether accumulated costs of unit click costs reach budget set by the advertiser 130. Also, in this step S1460, the impression management system 300 can determine whether accumulated cost information reaches information on the limited number of clicks. Also, in this step, the impression management system 300 can determine whether the accumulated number of valid clicks by a selection of the searcher 120 reaches the limited number of clicks set by the advertiser 130. Thus, there is an effect that it is possible to flexibly control a display closing time of the search listing in accordance with the advertising closing condition set by the advertiser 130.

In case that the advertising execution information satisfies the advertising closing condition in the step S1460, the impression management system 300 cuts off display of the search listing by the advertising record 310 (S1470). This step S1470 is a procedure for cutting off display of the search listing when a charge amount or the number of clicks generating by a selection of the searcher 120 with respect to the search listing satisfies the set advertising closing condition.

Thus, according to the present invention, it is possible to flexibly set an advertising period for which the search listing is displayed based on marketing strategies planned by the advertiser 130. Thus, there is an effect that a more effective advertising act is possible.

As another embodiment of the present invention, the impression management system 300 determines whether there is any connection between a second keyword and a first keyword. Depending on the determination, the impression management system 300 selectively extracts search listings from the search information database 345. At this time, the second keyword is inputted for a search request and the first keyword is recorded in the advertising record 310.

That is, the impression management system 300 enables a set control with respect to a search mode. Also, the impression management system 300 enables a search listing to be selectively extracted based on a connection between the first keyword and the second keyword, i.e., a selection of scope about same/similarity. The search mode used herein is any one of a basic search determining that the connection is valid in case that the second keyword is identical to the first keyword, an extension search determining that the connection is valid in case that a category of the second keyword is identical to that of the first keyword and a phrase search determining that the connection is valid in case that the first keyword is included in the second keyword. The impression management system 300 extracts search listings by referring to the advertising records 310, only in case that it is determined that the connection is valid. For example, in case that the search mode is set as the basic mode, the impression management system 300 can identify only the advertising record 310 maintaining the first keyword which is exactly identical to a keyword inputted as the second keyword, as impression information. On the other hand, in case that the search mode is set as the extension mode, the advertising record 310 maintaining a category of the first keyword which is identical to that of the second keyword is identified. For example, the advertising record 310 maintaining the first keyword as ‘car’ (a car category) is identified when ‘car’, ‘automobile’, ‘used car’, and the like is inputted. It is because the impression management system 300 recognizes a category of the second keyword as ‘automobile’ and determines that there is a connection between the second keyword and the first keyword.

Thus, it is possible to flexibly set a search mode most suitable for marketing strategies of the advertiser 130. Also, it is possible to extract search listings with respect to a keyword which is least selected as the first keyword by the advertiser 130. Thus, there is an effect that it is possible to activate keyword advertising and to make advertising benefits.

Also, the embodiments of the present invention include a computer readable medium including a program instruction for executing various operations realized by a computer. The computer readable medium may include a program instruction, a data file, and a data structure, separately or cooperatively. The program instructions and the media may be those specially designed and constructed for the purposes of the present invention, or they may be of the kind well known and available to those skilled in the art of computer software arts. Examples of the computer readable media include magnetic media (e.g., hard disks, floppy disks, and magnetic tapes), optical media (e.g., CD-ROMs or DVD), magneto-optical media (e.g., floptical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as produced by a compiler, and files containing high-level languages codes that may be executed by the computer using an interpreter.

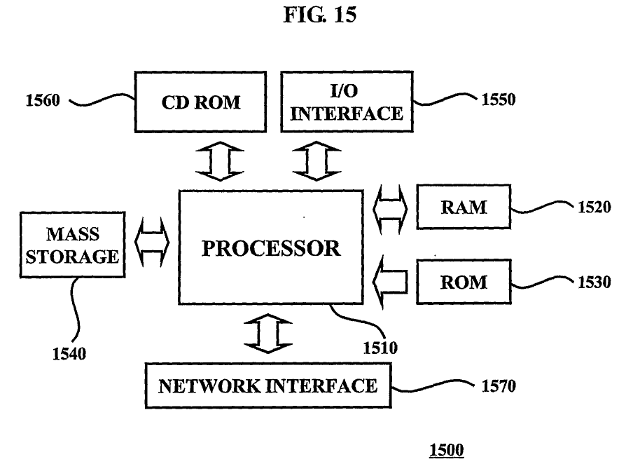

FIG. 15 is an inner block diagram of a general-purpose computer which may be employed to perform the impression management method according to the present invention.

A computer apparatus 1500 includes at least one processor 1510 connected to a main memory device including a RAM (Random Access Memory) 1520 and a ROM (Read Only Memory) 1530. The processor 1510 is also called as a central processing unit CPU. As well-known to the field of the art, the ROM 1530 unidirectionally transmits data and instructions to the CPU, and the RAM 1520 is generally used for bidirectionally transmitting data and instructions. The RAM 1520 and the ROM 1530 may include a certain proper form of a computer readable recording medium. A mass storage device 1540 is bidirectionally connected to the processor 1510 to provide additional data storage capacity and may be one of the computer readable recording medium. The mass storage device 1540 is used for storing programs and data and is an auxiliary memory. A particular mass storage device such as a CD ROM 1560 may be used. The processor 1510 is connected to at least one input/output interface 1550 such as a video monitor, a track ball, a mouse, a keyboard, a microphone, a touch-screen type display, a card reader, a magnetic or paper tape reader, a voice or hand-writing recognizer, a joy stick, and other known computer input/output unit. The processor 1510 may be connected to a wired or wireless communication network via a network interface 1570. The procedure of the described method can be performed via the network connection. The described devices and tools are well-known to those skilled in the art of computer hardware and software.

The hardware elements above may be configured to act as one or more software modules for implementing the operations of this invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. Therefore, it is intended that the scope of the invention be defined by the claims appended thereto and their equivalents.

Although the present invention has been described in connection with the embodiment of the present invention illustrated in the accompanying drawings, it is not limited thereto since it will be apparent to those skilled in the art that various substitutions, modifications and changes may be made thereto without departing from the scope and spirit of the invention.

### INDUSTRIAL APPLICABILITY

As aforementioned, according to the present invention, it is possible to provide method and system for managing an impression of a search listing, which can group at least one advertising record associated with extraction of the search listing into one advertising group and collectively change attribute for the grouped advertising record as a variable element for extraction of the search listing is inputted into an advertising group.

Also, according to the present invention, it is possible to provide method and system for managing an impression of a search listing, which limit an impression target for display of brief information by a region, an age, and a sex based on an advertiser's selection, thereby displaying the search listing to a searcher only who is most suitable for marketing strategies of the advertiser.

Also, according to the present invention, it is possible to provide method and system for managing an impression of a search listing, which cut off display of the advertising listing when advertising execution information generated by a searcher's selection satisfies a predetermined advertising closing condition, thereby enabling the advertiser to actively control his/her own advertising.

Also, according to the present invention, it is possible to provide method and system for managing an impression of a search listing, which guarantee diversity of a search mode extracting search listings based on a method of determining whether a keyword causing the extraction is associated with a keyword inputted for a search request.

What is claimed is

1. A computer-implemented method for managing an impression of a search listing, the method comprising the steps of:
storing a plurality of advertising records of search listings, at least some of the advertising records being associated with respective advertisers, the search listings being searchable in response to a query received from a searcher;
grouping at least some of the plurality of advertising records into at least one advertising group, each of the advertising records including impression information of a search listing, the impression information including a location information of the search listing to be displayed on a search result list;
receiving impression information on a search listing for an advertising group from an advertiser, the received impression information being associated with at least one of the advertising record under the advertising group;
recording said received impression information on the at least one advertising record under the advertising group; and
ordering search listings in the search result list according to the advertising records.

2. The method of claim 1, wherein:
the impression information includes at least one selected from the group consisting of information on a display time band of the search listing, information on an impression target thereof, and information on the allowed number of clicks of the searcher with respect to the search listing.

3. The method of claim 2, wherein:
information on the impression target includes at least one piece of information selected from the group consisting of information on a region where the search listing is displayed, age information, and sex information.

4. The method of claim 2, comprising the steps of:
recording variable data in the advertising group; and
collectively controlling impression information about at least a portion of the advertising record associated with the advertising group based on the recorded variable data.

5. The method of claim 1, wherein:
the advertising record includes information on a predetermined first unit click cost and click through rate (CTR) associated with display of the extracted search listing; and
the step of ordering search listings in the search result list according to the advertising records comprises the steps of:
in response to an inputted keyword for the search request, selecting the predetermined number of search listings, based at least in part upon the first unit click cost and CTR; and
sorting the selected search listing by considering the first unit click cost and CTR.

6. The method of claim 1, wherein:
the advertising record includes first unit click cost information associated with display of the search listing; and
the step of ordering search listings in the search result list according to the advertising records comprises the steps of:
dividing the advertising impression location into at least one unit display zone;
identifying a unit display zone corresponding to the ranking information from the divided unit display zones;
recording the first unit click cost in a predetermined bidding field associated with the identified unit display zone; and
in case that it is determined that the first unit click cost is successful by a bidding process in the bidding field, granting an impression right at the identified unit display zone to a search listing associated with the successful first unit click cost.

7. The method of claim 6, wherein:
the bidding process is performed in interoperation with recording the first unit click cost in the bidding field and it is determined that a unit click cost having the highest numerical value recorded in the bidding field is successful.

8. The method of claim 1, wherein:
the advertising record includes information on a unit click cost; and
the step of ordering search listings in the search result list according to the advertising records comprises the steps of:
receiving a selection of a searcher with respect to a search listing displayed on the advertising impression location; and
recording the unit click cost information in the advertising group as billing information, in correspondence to the selection.

9. The method of claim 1, wherein:
the step of ordering search listings in the search result list according to the advertising records comprises the steps of:
receiving channel information associated with a predetermined search engine and recording the channel information in the advertising record; and
recognizing a search engine in which the search request is generated, and identifying an advertising record recording channel information associated with the recognized search engine.

10. A computer-implemented method for managing an impression of a search listing, the method comprising the steps of:
recording impression information associated with display of a search listing in a an advertising record;
grouping at least one advertising record into an advertising group, each of the advertising records including impression information of a search listing, the advertising group including advertising closing condition data, the advertising closing condition data being associated with time period for the search listing to be displayed at the predetermined location;
displaying the search listing in a search result list in response to a searcher's search request according to the advertising closing condition included in the advertising group.

11. The method of claim 10, wherein the advertising group includes account balance and an advertising execution information and the advertising execution information is updated corresponding to a selection of the searcher with respect to the search listing and wherein the advertising closing condition is satisfied when the advertising execution information reaches the account balance.

12. The method of claim 10, wherein the advertising group includes advertising execution information and the advertising execution information is updated corresponding to clicks generated by a selection of the searcher with respect to the search listing.

13. A computer-implemented method for managing an impression of a search listing, the method comprising the steps of:
recording a first keyword causing the search listing to be extracted, in a predetermined advertising record, wherein the advertising record maintains channel information about a predetermined search engine displaying the search listing;
associating the at least one advertising record with an advertising group;
recording a predetermined search mode in the advertising group;
identifying a second keyword inputted for a search request at a search engine specified by the channel information;
determining whether there is any connection between the identified second keyword and the first keyword, based on the recorded search mode; and
in case that it is determined that the connection is valid, extracting the search listing by referring to the advertising record;
wherein the search mode is any one of a basic search determining that the connection is valid in case that the second keyword is identical to the first keyword, an extension search determining that the connection is valid in case that a category of the second keyword is identical to that of the first keyword and a phrase search determining that the connection is valid in case that the first keyword is included in the second keyword.

14. A computer-implemented method for managing an impression of a search listing, the method comprising the steps of:
maintaining an advertising record for recording impression information about extraction of the search listing and a location where the extracted search listing is displayed;
maintaining an advertising group for associating the at least one advertising record and recording advertising duration information about a period for which the search listing is displayed;
maintaining a campaign for associating the at least one advertising group and recording selection information about an impression target displayed by the search listing, wherein the selection information includes information on a region of the impression target, an age thereof, a sex thereof, and a channel thereof;
maintaining an advertiser account for associating the at least one campaign and recording amount information associated with display of the search listing;
in response to a search request at a search engine specified by the channel information, providing a searcher making the search request with the search listing based on the selection information, the advertising duration information and the impression information; and
enabling a predetermined bill occurring by a selection of the searcher with respect to the provided search listing to be paid by using the amount information.

15. A storage medium encoded with machine-readable computer program code for implementing the method recited claim 1.

16. A system for managing an impression of a search listing, the system comprising:
an advertising record for recording impression information associated with display of the search listing;
an advertising group associating the at least one advertising record;
an advertising condition receiving unit recording a predetermined advertising closing condition in the advertising group;
a result providing unit providing a searcher with a predetermined search listing based on the impression information, in response to a search request of the searcher;
an execution information generating unit receiving a selection of the searcher with respect to the provided search listing and recording advertising execution information generated in association with the selection, in the advertising group; and
an operation control unit comparing the recorded advertising execution information and the advertising closing condition and in case that the advertising execution information satisfies the advertising closing condition, cutting off providing of a search listing by the advertising record associated with the advertising group.

17. The system of claim 16, wherein:
the advertising condition receiving unit records predetermined budget data or predetermined data of the limited number of clicks, which are allocated to the advertising group, as the advertising closing condition; and
the operation control unit compares the budget data and accumulated cost information of a billing amount generating by a selection of the searcher with respect to the search listing, or compares the data of the limited number of clicks and information on the accumulated number of clicks with respect to clicks generating by a selection of the searcher with respect to the search listing.

18. A storage medium encoded with machine-readable computer program code for implementing the method recited in claim 10.
